(19) United States
(12) Patent Application Publication
(10) Pub. No.: US 2007/0037447 A1
(43) Pub. Date: Feb. 15, 2007

(54) Electrical connector for a flexible flat conductor and a switch device

(75) Inventors: Markus Gimbel, Baar-Ebenhausen (DE); Jorg Schlinkheider, Ingolstadt (DE); Stephan-Ernst Glaser, Heppenhelm (DE)

Correspondence Address: BARLEY SNYDER, LLC, 1000 WESTLAKES DRIVE, SUITE 275, BERWYN, PA, 19312, US

(73) Assignees: TYCO ELECTRONICS AMP GMBH, Bensheim (DE); AUDI AG, Ingolstadt (DE)

(21) Appl. No.: 10/595,341

(22) PCT Filed: Oct. 1, 2004
(86) PCT No.: PCT/EP04/10999

§ 371 Date: Apr. 11, 2006

(30) Foreign Application Priority Data
Oct. 15, 2003 (DE) 103 48 045.5

(51) Int. Cl. H01R 13/648

(52) U.S. Cl. 439/607

(57) ABSTRACT

An electrical connector for electrically contacting a conductive line (120) embedded in a foil cable (102), wherein the electrical connector comprises an insulating housing, which at least partially encloses the foil cable (102), and at least one contact element (116) for electrically contacting the conductive line (120), wherein the insulating housing comprises a contact housing (114), in which the at least one contact element (116) is received, and a foil holder (126), which is separated therefrom, which may be mechanically fixed to the foil cable (102) and is joined to the contact housing (114) such that the contact element (116) abuts the conductive line (120) in a contact region (118).

The present invention relates to an electrical connector for connecting to conductive lines of a foil cable.

The connector comprises an insulating housing, which at least partially encloses the foil cable, and at least one contact element for electrically contacting conductive lines embedded in the flat cable. The invention also relates to an electrical switch device comprising a switch module, which may be connected to a foil cable by means of an electrical connector of this type. The invention also relates to a foil holder for fixing an electrical connector to a foil cable, and to a method for assembling an electrical component on a foil cable.

The connection of electrical components, such as electrical switches, with corresponding wiring, is an extremely common problem in many industrial fields of application. In the field of motor vehicles, in particular, said connections must satisfy strict requirements with regard to the safety of electrical cables even under difficult operating conditions. On the other hand, because they are required in large numbers, said connectors must be configured as efficiently as possible with regard to material requirements and the number of operating steps involved.

Switches that actuate window lifting motors, seat inclining motors or the like, for example, are currently connected to the internal power supply via plug connections and intermediate wires. This solution has the drawback of a comparatively complex assembly, involving a large number of operating steps and a large amount of material.

The object of the present invention is therefore to provide an electrical connector for electrically contacting conductive lines of a foil cable, which ensures safe contacting and at the same time allows electrical components to be produced economically and be easily assembled. A further object of the present invention is to provide an electrical switch device that is safe and may at the same time be electrically contacted quickly, using small quantities of materials.

Said objects are achieved by a foil holder having the features of claim 1, by an electrical connector having the features of claim 6, and by an electrical switch device having the features of claim 11. Said object is also achieved by a method having the steps of claim 13.

In an exemplary embodiment of the present invention, a foil holder is mechanically fixed to the foil cable, and then a contact housing, having at least one contact element for electrically contacting the conductive lines, is joined to the foil holder. The contact element then produces the connection to an electrical component, such as an electrical switch device, a plug connector, or the like. A substantial advantage of this design is the small number of components and operating steps which are thus required for wiring electrical components, such as switches. It is considerably less expensive than conventional wiring of a switch on the trunk circuit. The electrical connector according to the invention also allows electrical components to be wired in very tight spaces.

The multipart configuration of the insulating housing also has the advantage that the foil holder may be assembled on the flexible flat conductor even when it would not be beneficial to assemble the remaining components. The foil holder also precisely defines the position on the foil cable to which the component will subsequently be connected.

Advantageous configurations of the present invention are the subject of a plurality of sub-claims.

According to an advantageous embodiment, the contact housing comprises at least one retaining clip, which at least partially engages the foil holder in a final, assembled position. This allows the contact housing to be fixed to the foil holder in a particularly safe manner. Safe electrical contacting is ensured, even in the event of relatively high mechanical and thermal loads, such as can occur in the field of motor vehicles.

The contact housing may also be configured such that it may be displaced, with respect to the foil holder, from a pre-assembled position into the final, assembled position, parallel to the plane defined by the foil cable. This facilitates a final assembly in which the foil cable is not stressed unnecessarily, although contact elements, in particular resilient contact elements, are placed on the conductive line to be contacted with a sufficient degree of safety.

In order to prevent the connection between the contact housing and the foil holder from becoming accidentally undone in the final, assembled position, a locking device, which locks with the foil holder in the final, assembled position, may be provided on the contact housing.

According to a further advantageous embodiment, the foil holder comprises at least one aperture, through which the at least one contact element is inserted in order to contact the at least one conductive line. This ensures the contactability of the conductive line in a particularly simple manner. Depending on the formation of the contact elements, the insulation of the flexible flat conductor may be removed via the corresponding contact points of the conductive lines.

The contact element may comprise a connection region, which is configured such that it may be connected to a circuit board. This allows an electrical component which is assembled on a circuit board, such as a switch arrangement, to be directly contacted with the foil cable.

The connection to the circuit board may advantageously be in the form of a solderless press-in connection (configuration of the connection region as what is know as an “action pin”). This is particularly advantageous if components that would not be able to withstand the thermal load caused by a soldering step are assembled on the circuit board. However, for specific applications, it may also be beneficial to connect the circuit board to the contact elements using a soldered joint or other conventional connection techniques.

According to an advantageous development, the foil holder comprises two half-shells, between which the foil cable may at least partially be received. The foil holder may thus be fixed on the foil cable by means of simple clamping. A strain-relief device may provide additional mechanical support.

In order to facilitate the secure positioning of the two half-shells during assembly and to facilitate the positioning of the foil cable relative to the foil holder, the foil holder may be equipped with a hinge-like connection, with which the two half-shells may be connected such that they may be folded in order to fit together, such as a hinge connection with an axis of rotation that extends in the direction of the longitudinal axis of the foil cable.

Safe electrical contacting that requires little mechanical force during assembly may be achieved by using contact elements, the contact region of which is configured as a spring arm. Inadmissible mechanical stress on the foil cable is thereby avoided. However, in a configuration of the contact elements of this type, the region of the conductive lines that is to be contacted must firstly have the insulation removed. If it is desirable to dispense with the preliminary insulation removal, a contact region may alternatively be provided that cuts through the insulation, during the assembly of the contact housing, in the manner of a knife.

The advantages of the electrical connector according to the invention are particularly effective if it is used in conjunction with a switch module arranged on a circuit board. This allows a switch, in the field of motor vehicles, for example, to be directly connected to a foil cable. As well as a considerable reduction in expenditure, as a result of the smaller quantity of materials required, and a simplification of the assembly procedure, this solution has the further advantage that the switch may be wired in an extremely compact manner.

The invention will be explained below in greater detail with reference to the exemplary embodiments shown in the accompanying drawings. Similar or corresponding individual parts of the subject according to the invention are provided with the same reference numerals. In the drawings:

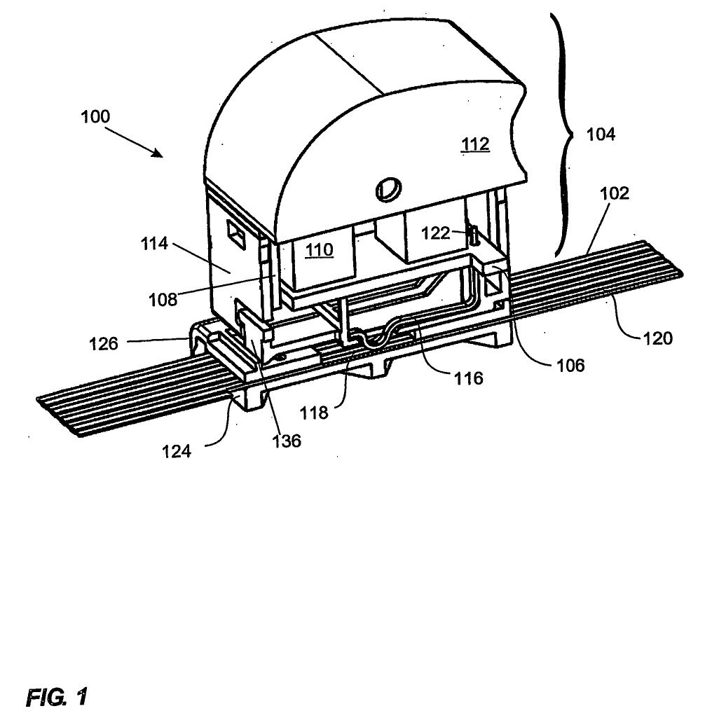

FIG. 1 is a perspective illustration, partially in section, of a switch device, which is electrically connected to conductors of a foil cable according to an exemplary embodiment of the invention;

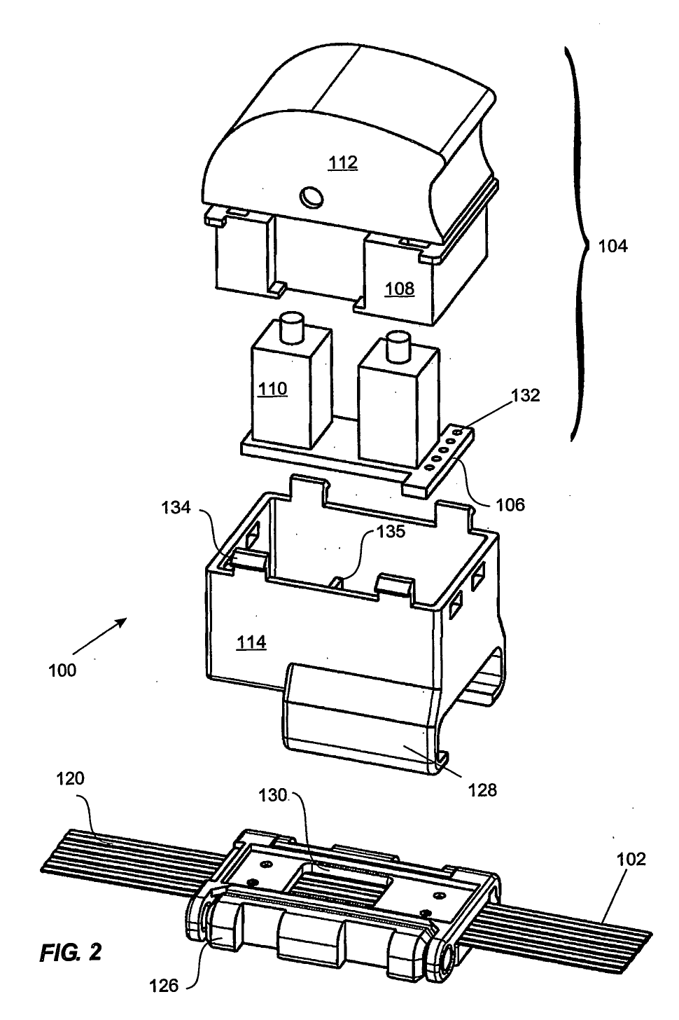

FIG. 2 shows a partially exploded, perspective illustration of the switch and cable arrangement from FIG. 1;

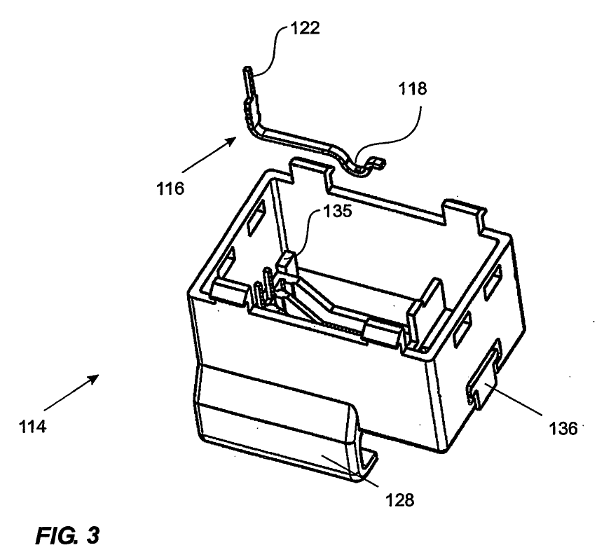

FIG. 3 shows a perspective illustration of a contact housing of the switch device of FIG. 1;

FIG. 4 shows a perspective illustration of a foil holder of the switch device of FIG. 1, prior to assembly on a foil cable;

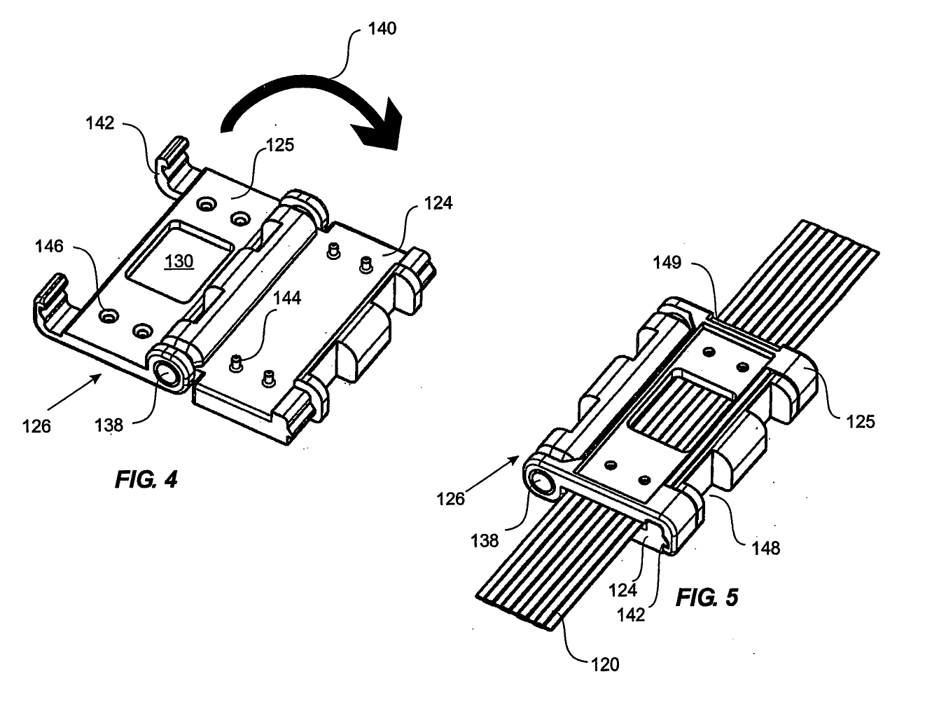

FIG. 5 shows a perspective illustration of a foil holder of FIG. 4, after assembly on a foil cable;

FIG. 6 shows the switch arrangement from FIG. 1, prior to assembly of the contact housing, which houses a switch module;

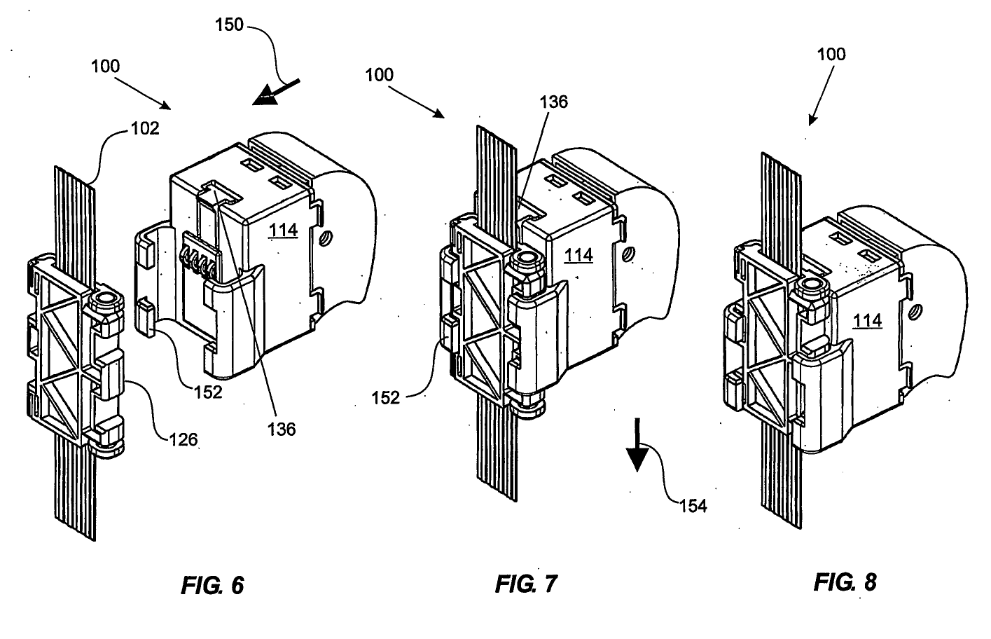

FIG. 7 shows the arrangement from FIG. 6, after the contact housing in a pre-assembled state has been connected to the foil holder; and

FIG. 8 shows the arrangement from FIG. 1 in the final, assembled state.

FIG. 1 shows a switch device 100 according to an exemplary embodiment of the present invention, the switch device 100 being connected to a foil cable 102. According to the invention, a switch module 104 is received in a contact housing 114. The switch module comprises two switch elements 110 that are arranged on a circuit board 106 and enclosed by a switch housing 108. The contact housing contains contact elements 116 for contacting the circuit board 106. The switch elements 110, in this exemplary embodiment two microprobes, are actuated via a rocker 112. At one end, the contact elements 116 have a contact region 118, with which they produce the connection to electrical conductive lines 120, which are embedded in the foil cable 102. On the other end, the contact elements 116 comprise a connection region 122, which is electrically connected to the circuit board 106.

In the embodiment shown herein, the connection region 122 is configured as what is known as an “action pin”, i.e. the electrical connection to the circuit board 106 is produced via a solderless press-in connection. However, other configurations of the connection region may of course also be provided, depending on the design of the switch module 104.

As may be seen in FIG. 1, the electrical contact between the conductive line 120 and the contact element 116 is effected by the spring force of the contact element 116, which is configured as a spring arm. The required counter-pressure and the necessary stabilisation of the foil cable 102 are provided by a lower bearing surface, in this case a lower half-shell 124 of a foil holder 126.

According to the invention, the foil holder 126, which partially encloses the flexible flat conductor 102, is a separate part, which, as will become apparent from the following figures, may be assembled on the flat cable 102 without the remaining components, and is only subsequently connected to the contact housing 114 and the switch module 104 embedded therein.

FIG. 2 shows a partially exploded illustration of the individual components of the switch device from FIG. 1. It may be seen from said illustration that the contact housing 114 comprises retaining clips 128, which mechanically fix both the contact housing 114 and the switch module 104 embedded therein to the foil holder 126. A precisely defined and sufficiently stable pressing of the contact elements onto the conductive lines 120 may thus be ensured.

On the side facing the contact housing 114, the foil holder 126 is provided with an aperture 130, through which the contact elements 116 may be inserted, in order to contact the conductive lines 120. If the contact elements 116 are resilient contact arms, as shown in FIG. 1, insulation must be removed from the conductive lines 120 in the region of the aperture 130, either prior to or after assembly of the foil holder 126. Alternatively, knife-like contact elements 116, which cut through the insulation in the region of the aperture 130, via the conductive lines 120, may be provided.

In the embodiment shown, the rocker 112 is assembled on a switch housing 108, which encloses the switch elements 110 arranged on the circuit board 106. Contacting holes 132, which are arranged on the circuit board 106, allow the contact elements 116 to be connected, as shown in FIG. 1. The contact housing 114, which may be made from a plastic material, using the injection-moulding technique, for example, comprises locking devices 134 for locking to the switch housing 108. Bearing projections 135, which are moulded onto the contact housing 114, prevent the circuit board 106 from getting too close to the foil cable 102.

FIG. 3 shows a perspective, slightly inclined illustration of the contact housing 114, with one of the contact elements 116 assembled therein being shown in isolation, for the sake of clarity. In the embodiment shown, the contact elements 116 (of which there are in this case four, although any number may be used) are configured as spring arms, of which the contact region 118 is bent such that, in the assembled state, it is pressed against the conductive line 120 as a result of the spring force of the contact element 116.

The connection region 122 of the contact element 116 is configured such that it may be connected to the circuit board 106 via a solderless press-in connection. As may be seen in conjunction with FIG. 1, and will be illustrated in greater detail with reference to FIGS. 6 to 8, an additional locking device 136 allows the contact housing 114 to be locked with the foil holder 126 in the final, assembled state.

FIG. 4 shows a perspective illustration of the foil holder 126, prior to its assembly on the foil cable 102. The foil holder 126 is formed by two half-shells 124 and 125. The two half-shells 124, 125 are connected to each other via a hinge 138, such that the two half-shells may be assembled on the foil cable 102 by folding the upper half-shell 125 in the direction shown by arrow 140.

After folding, the two halves 124, 125 enclose the foil cable 102, as shown in FIG. 5, and are locked together via locking devices 142. During assembly, strain-relief pins 144 penetrate the foil cable 102 and are inserted into apertures 146 in the upper half-shell 125. Here too, locking projections may be provided for additional mechanical protection. The conductive lines 120 of the foil cable 102 are electrically contacted through the aperture 130. Assembly recesses 148 allow the contact housing 114 to be attached to the foil holder 126 in a pre-assembled state, as will be illustrated in greater detail with reference to FIGS. 6 to 8.

The assembly of the switch device 100 on a foil cable 102 will now be illustrated in detail with reference to FIGS. 6 to 8. Firstly, the switch module 104 is embedded in the contact housing 114, in which the contact elements 116 are already assembled. The individual switch elements 110 are thus electrically connected to the contact elements 116 via the circuit board 106.

As has already been explained with reference to FIGS. 4 and 5, the foil holder 126 is positioned on the flexible flat conductor 102 such that the aperture 130 (which cannot be seen in this figure) presents the regions to the contacted of the conductive lines 120 to the contact elements 116. The contact housing 114 is then moved toward the foil holder 126 in a direction transverse to the longitudinal axis of the foil cable 102, denoted by the direction arrow 150, such that projections 152 may be inserted through the recesses 148.

The assembled state, which is then achieved, is shown in FIG. 7. In said state, the contact elements 116 have not yet reached their final position and the contact housing has not yet been completely fixed on the foil holder 126.

In a movement extending substantially parallel to the longitudinal axis of the flexible flat conductor 102 (denoted by the direction arrow 154), the contact housing 114 is then displaced relative to the foil holder 126 such that the projections 122 of the retaining clips 128 are fixed on the foil holder 126, and the locking hook 136 locks with the edge 149 on the foil holder 126. Said final, assembled state is shown in FIG. 8.

Although the assembly of a switch device on a flexible flat conductor is shown in the accompanying figures as an exemplary technical configuration, other electrical components may of course also be contacted in the same manner. In addition to the foil cables, any other flat flexible conductor arrangement, such as flat band conductors, for example, may also be contacted in this manner.

1. Foil holder for fixing an electrical connector to a foil cable comprising at least one conductive line, the foil holder being configured such that a contact housing, which comprises at least one contact element for electrically contacting the conductive line, may be assembled on the foil holder such that contact element abuts the conductive line in a contact region.

2. Foil holder according to claim 1, characterised by at least one aperture, through which the conductive line may be contacted by the at least one contact element.

3. Foil holder according to either claim 1 or claim 2, characterised in that the foil holder comprises two half-shells, between which the foil cable may be at least partially received.

4. Foil holder according to claim 3, characterised in that the two half-shells of the foil holder are connected by a hinge connection, such that the two half-shells may be folded in order to fit together.

5. Foil holder according to claim 4, characterised in that the hinge connection has an axis of rotation that extends in the direction of the longitudinal axis of the foil cable.

6. Electrical connector for electrically contacting a foil cable with at least one conductive line embedded in a foil, wherein the electrical connector comprises an insulating housing, which at least partially encloses the foil cable, and at least one contact element for electrically contacting the conductive line,
wherein the insulating housing comprises a contact housing, in which the at least one contact element is received, and a foil holder according to any one of claims 1 to 5, which is separated therefrom.

7. Electrical connector according to claim 6, characterised in that the contact housing comprises at least one retaining clip, which at least partially engages the foil holder in a final, assembled position.

8. Electrical connector according to either claim 6 or claim 7, characterised in that the contact housing is configured such that it may be displaced, with respect to the foil holder, from a pre-assembled position into the final, assembled position, parallel to the plane defined by the foil cable.

9. Electrical connector according to any one of claims 6 to 8, characterised in that at least one locking device is moulded onto the contact housing, and the locking device locks with the foil holder, in order to mechanically secure the contact housing in the final, assembled position on the foil holder.

10. Electrical connector according to any one of claims 6 to 9, characterised in that the contact element is constructed as a spring arm and, in the final, assembled position, the contact region may be pressed against the conductive line.

11. Electrical switch device having a switch module, which comprises at least one switch element arranged on a circuit board, wherein the switch module may be connected to a foil cable by means of an electrical connector according to any one of claims 6 to 10.

12. Electrical switch device according to claim 11, characterised in that two probes, which may be actuated by a rocker, are arranged on the circuit board.

13. Method for assembling an electrical component on a foil cable, comprising the following steps;
connecting a foil holder to the foil cable;
connecting the electrical component to a contact housing, which comprises at least one contact element for electrically contacting at least one conductive line of the foil cable;
assembling the contact housing on the foil holder.

14. Method according to claim 13, characterised in that the step of connecting the foil holder to the flexible flat conductor includes:
placing a first half-shell of the foil holder on the foil cable; and
connecting the first half-shell to a second half-shell, so that the foil cable is at least partially enclosed by the foil holder.

15. Method according to claim 14, characterised in that the step of connecting the two half-shells includes:
connecting the two half-shells by means of a hinge connection;
folding the second half-shell about an axis of rotation of the hinge connection, the axis of rotation extending in the direction of the longitudinal axis of the foil cable.

16. Method according to any one of claim 13 to 15, characterised in that the step of assembling the contact housing on the foil holder includes:
assembling the contact housing on the foil holder in a pre-assembled position;
displacing the contact housing in the direction of the longitudinal axis of the foil cable until the at least one contact element contacts the conductive line of the foil cable in a final, assembled position.
